(19) United States
(12) Patent Application Publication
(10) Pub. No.: US 2026/0111896 A1
(43) Pub. Date: Apr. 23, 2026

(54) Systems and Methods for Online Anomaly Detection

(71) Applicant: CHEWY, INC., Plantation, FL (US)

(72) Inventors: Sundararajan Srini Srinivasan, North Attleboro, MA (US); Soumen Das, Shrewsbury, MA (US); Zachary Allen, Boston, MA (US); Shilpa Ganesan, Hopkinton, MA (US); Tyler Harpole, Richfield, MN (US); Chaitanya Kelkar, Dorchester, MA (US)

(21) Appl. No.: 19/357,430

(22) Filed: Oct. 14, 2025

Related U.S. Application Data
(60) Provisional application No. 63/708,572, filed on Oct. 17, 2024.

(51) Int. Cl. G06Q 20/40; G06Q 20/12

(52) U.S. Cl. CPC G06Q 20/4016; G06Q 20/12

(57) ABSTRACT

An anomaly detection system for e-commerce platforms can integrate multiple user touchpoints via a unified interface. Real-time data ingestion may process and store information in a anomaly data lake. A graphical database can link user interactions, devices, accounts, and transactions. A neural network may analyze this data to predict identities and detect anomaly patterns, potentially providing risk assessments. Machine learning models can generate risk scores for accounts and transactions. A anomaly orchestration system may combine assessments and scores, applying dynamic rules to implement prevention actions. The system can capture data throughout the user journey, enabling adaptive protection against evolving anomaly tactics. By integrating advanced analytics and real-time processing, the system may make informed decisions to block, allow, or challenge user actions across the e-commerce platform.

### CROSS-REFERENCE TO RELATED APPLICATIONS

This application claims the benefit of U.S. Provisional Patent Application No. 63/708,572 filed Oct. 17, 2024 entitled “Systems and Methods for Online Fraud Detection”, which is incorporated by reference herein in its entirety.

### TECHNICAL FIELD

The disclosed embodiments relate generally to e-commerce security and more specifically to systems and methods for online anomaly detection throughout a user's journey on an e-commerce platform such as, but not limited to, online fraud detection.

### BACKGROUND

E-commerce has revolutionized the way people shop, offering convenience and accessibility to consumers worldwide. However, this digital transformation has also opened up new avenues for anomalous activities including, but not limited to, fraudulent activities. As e-commerce platforms evolve, so do the tactics employed by bad actors such as, for example, fraudsters, making it increasingly challenging for online retailers to protect their businesses and customers. Traditional fraud detection methods often focus on specific points in the customer journey, such as the moment of transaction. However, these approaches have limitations. Conventional methods may detect an anomaly too late in the process, after sensitive information has already been compromised. Traditional systems can create unnecessary friction for legitimate customers, leading to abandoned transactions and reduced customer satisfaction. Current systems may not account for the evolving nature of anomalous activities (e.g., fraud) across different touchpoints in the user journey. Moreover, as e-commerce platforms expand to offer new services and verticals, the complexity of anomaly detection increases. Each new service or touchpoint introduces potential vulnerabilities that fraudsters or other bad actors can exploit.

### SUMMARY

Accordingly, there is a need for systems and methods that address at least some of the problems described above. The techniques described herein address at least some of the challenges described above by providing a centralized, intelligent anomaly detection system that leverages advanced technologies, such as machine learning and graphical databases, to offer real-time, comprehensive protection throughout a user's journey on an e-commerce platform. Aspects of the system disclosed herein can provide comprehensive and/or adaptive anomaly detection that can help protect users at different stages of their e-commerce journey, from account creation to post-purchase activities, minimize friction for legitimate users while maintaining robust security measures, adapt quickly to new types of anomalies and changes in the e-commerce landscape, and/or provide a unified integration experience for e-commerce platforms, allowing for easy implementation across various touchpoints and services.

Some embodiments provide an anomaly detection system for protecting an e-commerce platform throughout a user's journey. The system may include several components working in concert to provide comprehensive, real-time anomaly detection and prevention. The system may include a unified application interface that integrates with multiple user touchpoints across the e-commerce platform. This interface may receive attributes associated with each user touchpoint and/or may return decisions to block, allow, or challenge user actions based on risk assessments. The system may employ a data ingestion pipeline that captures and/or processes real-time data from integrated touchpoints. This data may be transformed and/or stored in an anomaly data lake, providing a rich source of information for analysis and decision-making. A graphical database may be used to link user interactions, devices, accounts, and transactions across the e-commerce platform. This database may be continuously updated with new data from the ingestion pipeline, allowing for the detection of complex patterns and relationships that may indicate anomalous behavior.

In some embodiments, the system may leverage a neural network associated with the graphical database to analyze the linked data, predict user identities, and/or detect patterns indicative of anomalous behavior. This neural network may provide real-time risk assessments for each user action. Multiple machine learning models, for example account risk scoring, transaction risk scoring, and/or returns risk scoring models, may use data from the anomaly data lake and/or predictions from the neural network to generate risk scores for user accounts and/or individual transactions. An anomaly orchestration system may tie these components together, receiving risk assessments and scores, and/or applying a set of dynamic rules to implement appropriate anomaly prevention actions. These actions can include blocking, allowing, or challenging user actions based on the assessed risk. The system may be designed to detect and prevent anomalous activities at the earliest possible stage of the user journey, including account creation. The system may employ dynamic authentication measures and/or may adapt to new threats through unsupervised learning techniques and/or real-time model adjustments. By providing end-to-end protection across multiple touchpoints and balancing user experience with security, the anomaly detection system described herein offers a comprehensive solution for e-commerce platforms seeking to protect their users and businesses from evolving anomalous threats.

In accordance with some embodiments, a method executes at a computer system having one or more processors and memory storing one or more programs configured for execution by the one or more processors. The computer system (e.g., a anomaly detection system) may be used for protecting an e-commerce platform throughout a user's journey may comprise several components. A unified application interface may integrate with multiple user touchpoints, receive attributes associated with each touchpoint, and return decisions to block, allow, or challenge user actions. A data ingestion pipeline may capture and process real-time data from integrated touchpoints, transforming and storing the data in an anomaly data lake. A graphical database may link user interactions, devices, accounts, and transactions across the platform, updating with new data from the pipeline. A neural network associated with the database may analyze linked data to predict user identities and detect anomalous behavior patterns, providing real-time risk assessments for each action. The system may include multiple machine learning models, such as account and transaction risk scoring models, which may use data from the lake and neural network predictions to generate risk scores. A anomaly orchestration system may receive risk assessments and scores, applying dynamic rules to implement anomaly prevention actions for each user action.

In some embodiments, the system provides a model hierarchy. The machine learning models may include a returns risk scoring model. The account risk model may generate scores for each user account and use transaction and returns risk scores in subsequent calculations. The transaction risk model may use the account risk score to generate transaction risk scores. The returns risk model may use both account and transaction risk scores to generate returns risk scores for each request.

In some embodiments, the system provides specialized risk models. These may include an account creation risk model to assess anomalous account creation attempts and a behavior anomaly detection model to identify deviations from established user activity patterns.

In some embodiments, the system provides connection mapping. The graphical database may establish connections between seemingly unrelated accounts based on shared attributes and provide visual representations for manual review in complex cases.

In some embodiments, the system provides early-stage anomaly detection and prevention. The system may detect and prevent anomalous activities at the earliest possible stage, including account creation, by analyzing attributes, comparing the attributes against known anomalous patterns, generating initial risk scores, and triggering prevention actions if necessary.

In some embodiments, the system provides dynamic authentication and security measures. The anomaly orchestration system may adjust authentication levels based on risk scores and specific actions, implementing gradual security step-ups for increasingly risky actions to balance user experience with anomaly prevention.

In some embodiments, the system provides routing of high-risk actions to third-party services. The anomaly orchestration system may route high-risk actions to additional verification services when necessary.

In some embodiments, the system provides integration across multiple touchpoints. The unified interface may integrate with additional touchpoints like password reset requests and assign different risk thresholds based on potential anomaly impact at each stage.

In some embodiments, the system provides comprehensive user behavior profiling. The data ingestion pipeline may create user behavior profiles by processing data from multiple touchpoints and flag sudden changes for immediate risk assessment.

In some embodiments, the system provides evolving user risk profiles. The system may maintain risk profiles that evolve throughout the user journey, informing decisions at each subsequent touchpoint.

In some embodiments, the system provides account takeover prevention. The system may detect and prevent account takeover attempts by analyzing login patterns and implement verification steps for high-risk account changes.

In some embodiments, the system provides unsupervised learning and real-time model adjustment. The neural network may identify new anomalous behavior patterns and adjust prediction models in real-time based on outcomes.

In some embodiments, the system may further include a rules engine for dynamic rule creation and modification. This engine may allow rule changes without system downtime and suggest new rules based on identified patterns.

In some embodiments, the system provides adaptive anomaly prevention routing. The orchestration system may dynamically route actions to different services based on characteristics and risk assessment, aggregating decisions when necessary.

In some embodiments, the system provides continuous risk assessment updates. The system may continuously update assessments by processing real-time data, refining user profiles, re-analyzing data, recalculating risk scores, and adjusting prevention actions accordingly.

In some embodiments, the system provides dynamic adaptation to new services. The system may adapt to new platform additions by integrating with new touchpoints, updating data processing, extending the database schema, retraining models, and updating anomaly prevention strategies.

In some embodiments, the system provides reduced friction for legitimate users. The system may establish behavior baselines, compare actions against these baselines, implement tiered authentication, and continuously refine risk profiles to distinguish between legitimate and anomalous activities.

In some embodiments, the system may further include a feature store. This store may maintain pre-computed features from historical data and provide the features in real-time to models for faster, more accurate assessments.

In some embodiments, the system may further include a reporting and analytics module. This module may provide real-time dashboards and generate detailed reports on anomaly patterns and prevention effectiveness.

In some embodiments, the system provides third-party integration and compliance. The system may integrate with external data sources to enrich user data and maintain compliance with privacy regulations.

In some embodiments, the system may further include a simulation environment. This environment may allow testing of new strategies using historical data and assess potential impacts of rule changes on false positive and negative rates.

In another aspect, an electronic device includes one or more processors, memory, a display, and one or more programs stored in the memory. The programs are configured for execution by the one or more processors and are configured to perform any of the methods described herein, according to some embodiments.

In another aspect, a non-transitory computer readable storage medium stores one or more programs configured for execution by a computing device having one or more processors, memory, and a display. The one or more programs are configured to perform any of the methods described herein, according to some embodiments.

Thus, methods, systems, and interfaces are disclosed that protect an e-commerce platform throughout a user's journey.

Both the foregoing general description and the following detailed description are exemplary and explanatory, and are intended to provide further explanation of the invention as claimed.

### BRIEF DESCRIPTION OF THE DRAWINGS

For a better understanding of the aforementioned systems, methods, and graphical user interfaces, as well as additional systems, methods, and graphical user interfaces that provide data visualization analytics, reference should be made to the Description of Embodiments below, in conjunction with the following drawings in which like reference numerals refer to corresponding parts throughout the figures.

FIGS. 1A and 1B are schematic diagrams of an example anomaly detection system for protecting an e-commerce platform, according to some embodiments.

FIG. 2 is a schematic diagram of an implementation of an example anomaly as a service application programming interface (API), for an account registration process, according to some embodiments.

FIG. 3 is a schematic diagram of an example machine learning model hierarchy for an anomaly detection system, according to some embodiments.

FIGS. 4A and 4B are schematic diagrams of an example machine learning infrastructure of an anomaly detection system, according to some embodiments.

FIG. 5 is an example visual representation provided by an identity graphing database, according to some embodiments.

FIG. 6 shows an example dashboard for monitoring email change and password reset activity by date, according to some embodiments.

Reference will now be made to embodiments, examples of which are illustrated in the accompanying drawings. In the following description, numerous specific details are set forth in order to provide a thorough understanding of the present invention. However, it will be apparent to one of ordinary skill in the art that the present invention may be practiced without requiring one or more of these specific details.

### DESCRIPTION OF EMBODIMENTS

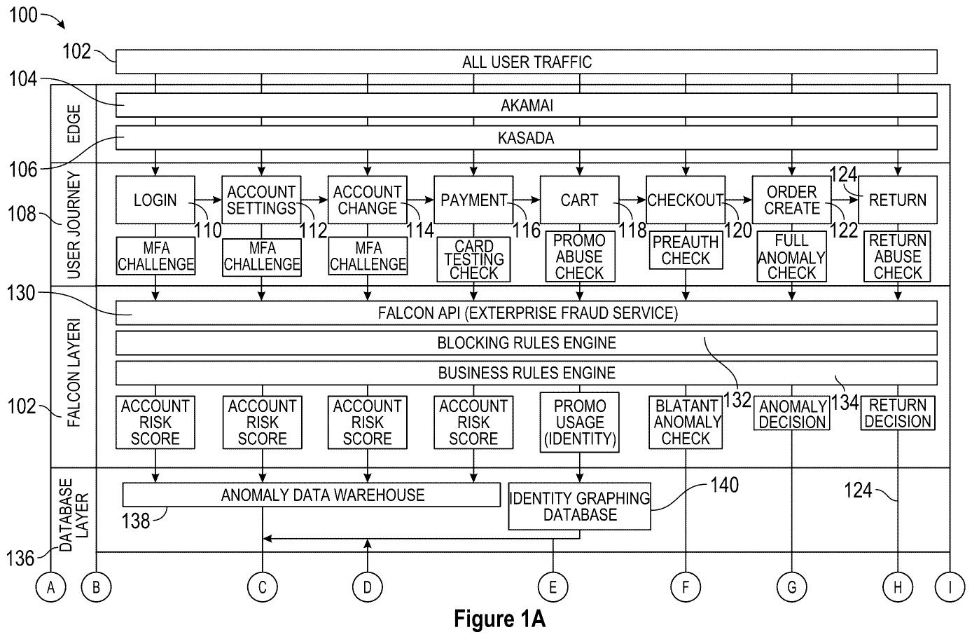

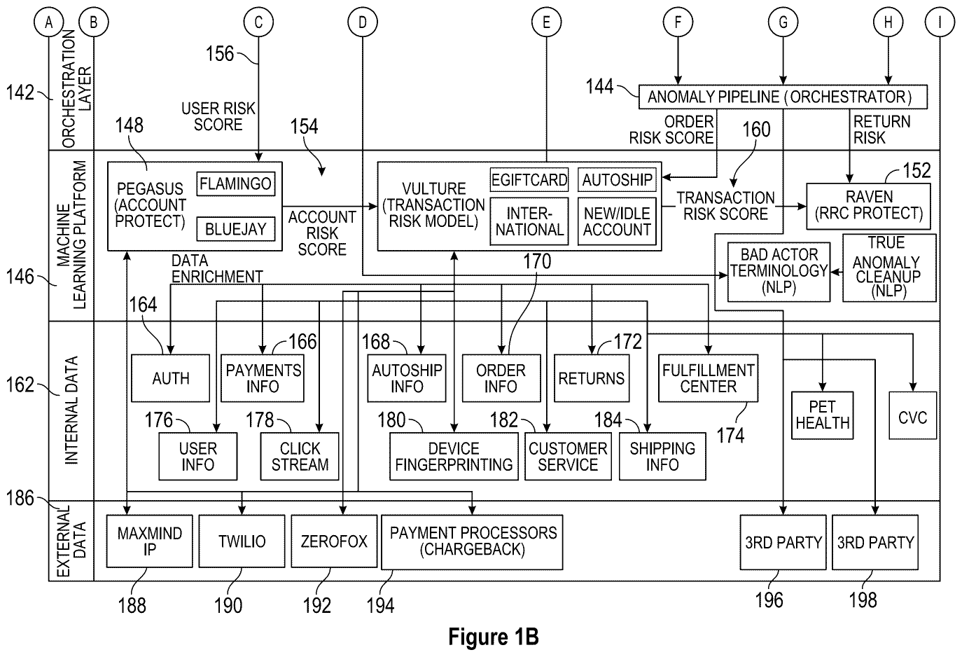

FIGS. 1A and 1B are schematic diagrams of an anomaly detection system 100 for protecting an e-commerce platform, according to some embodiments. The system 100 may comprise several interconnected components that may work together to provide comprehensive anomaly prevention capabilities (e.g., fraud prevention capabilities) throughout a user's journey. The system 100 may handle the flow of user traffic 102 through edge services (e.g., Akamai 104, Kasada 106), which may handle content delivery and/or bot mitigation. These edge services may process incoming traffic before it reaches the main system components. In some embodiments, an anomaly may be, but is not limited to, suspected fraudulent activities and/or fraudulent activities (e.g., fraud) or the like.

The user journey 108 may include a series of touchpoints, which may include, for example, login 110, account settings 112, address change 114, payment 116, cart 118, checkout 120, order create 122, and return 124. Each of these touchpoints may have an associated anomaly check. For login 110, there may be an multi-factor authentication challenge (MFA challenge). Account settings 112 and address change 114 may also have MFA challenges. Payment 116 may involve a card testing check 128. Cart 118 may include a promotion abuse check. Checkout 120 may have a pre-authorization check. Order create 122 may involve a full anomaly check. Return 124 may include a return abuse check. These checks may be connected to an application programming interface (API), indicating that they may receive anomaly prevention decisions from the system (e.g., fraud prevention decisions). The API may include an enterprise fraud service 130, a blocking rules engine 132, and/or a business rules engine 134. The API may interface with various components to make anomaly-related decisions. The API may receive inputs from the user journey touchpoints and may send outputs to an anomaly orchestrator 144.

The system 100 may also include a database layer 136 that may include an anomaly data warehouse 138 and/or an identity graphing database 140. These databases may store and process data related to user interactions and/or anomaly patterns (e.g., fraud patterns). The anomaly data warehouse 138 may receive account risk scores and/or may provide user risk scores to one or more machine learning models in a machine learning platform 146. The system 100 may also include an orchestration layer 142, which may include the anomaly orchestrator 144 responsible for coordinating anomaly prevention actions based on inputs from various parts of the system. The anomaly orchestrator 144 may receive inputs from the API and may output anomaly decisions.

The system 100 may also include a machine learning platform 146, which may include one or more machine learning models, which may include, for example, account protect models 148 (e.g., one or more models for different aspects of account protection, such as for detecting unusual login patterns, identifying suspicious account changes, and/or assessing the risk of account takeover attempts), transaction risk model 150, and/or return risk calculation model 152. These models may generate various risk scores, which may include, for example, account risk score 154, user risk score 156, order risk score 158, and/or transaction risk score 160. The account risk score 154 may assess the overall risk associated with a user account. The user risk score 156 may evaluate the risk of a specific user action. The order risk score 158 may assess the risk associated with a particular order. The transaction risk score 160 may evaluate the risk of a specific financial transaction.

The transaction risk model 150 may be designed to assess the risk associated with individual transactions. The model 150 may receive inputs from various data sources, including the account risk score 154 and user risk score 156, analyze transaction-specific details such as purchase amount, item type, shipping address, payment method, and/or timing, consider historical transaction patterns for the account, and/or generate the transaction risk score 160 as output. This score may be used by the anomaly orchestrator 144 to make decisions about whether to allow, block, or further scrutinize a transaction. The return risk calculation model 152 may assess the risk associated with product return requests, consider inputs such as the account risk score 154, transaction risk score 160, and data from the returns 172 internal source, analyze factors like return frequency, time since purchase, product condition, and/or return reason, generate a return risk score, and/or provide output to the anomaly orchestrator 144 to determine if a return should be processed normally, flagged for review, or denied.

The models 150 and 152 may work in conjunction with other system components. The models may, for example, receive data from the anomaly data warehouse 138 and/or the identity graphing database 140. Their outputs may feed into the anomaly orchestrator 144 for final decision-making. The models may interact with various internal data sources 162 for additional context and information. These models may focus on transaction-level and return-specific risks, respectively. In this way, the system provides a comprehensive approach to anomaly detection that considers multiple aspects of user interaction with the e-commerce platform.

The system 100 may also process promotion usage (identity) information and perform a blatant anomaly check (e.g., a blatant fraud check), which may feed into the anomaly orchestrator 144 for decision-making. The system may integrate with the one or more internal data sources 162, which may include, for example, authorization 164, payments 166, auto-ship 168, order management system (OMS) 170, returns 172, and fulfillment center 174. Additional internal data sources may include Kyrios 176, Segment (click stream) 178, CID (fingerprint) 180, CSRB 182, and/or WIZMO 184. The OMS 170 handles orders from creation to routing and fulfillment. The WIZMO 184 is a system that handles events during shipment and delivery (e.g., FedEx events). The CID 180 is a customer interactive datastore, which stores information related to devices and device management for that customer account. The CSRB 182 is a customer service tool to manage workflows and customer interactions. These internal data sources may provide inputs to the machine learning models and/or the anomaly data warehouse.

The system may connect to external data sources 186, which may include, for example, MaxMind IP 188, Twilio 190, ZeoFox 192, payment processors (chargebacks) 194, and/or third-party services (e.g., services 196, 198). These external sources may provide additional data inputs to enhance the system's anomaly detection capabilities.

In some embodiments, the anomaly detection system 100 may protect e-commerce platforms from potentially anomalous activities throughout a user's journey. The system 100 may centralize anomaly decisions (e.g., fraud decisions) into a single service, which may offer a unified integration experience for e-commerce websites while providing anomaly prevention capabilities (e.g., fraud prevention capabilities). The system may be configured to assess risk and make anomaly-related decisions at various entry points in the customer journey. These decisions may result in allowing, blocking, or challenging customer actions based on the assessed potential risk. The system may recognize that different touchpoints in the user journey may carry different threats and may take this into account when making decisions.

In some embodiments, the system 100 may include a feature to challenge users in situations where the risk is not clearly high or low. This “challenge-a-user” functionality may leverage various techniques, such as, for example, reCAPTCHA, crypto challenges, multi-factor authentication, and/or magic links at different integration points to verify customer identity. The system may include a unified anomaly decisioning service that may act as a central source for anomaly decisions (e.g., fraud decisions) across the e-commerce platform. This service may abstract various risk rules that might otherwise be distributed across different implementations within the e-commerce platform's codebase. The service may offer dynamic risk scoring for users with the help of an underlying AI/ML engine, which may be powered by data ingested from various sources, such as customer behavior across channels, order transactions, customer interactions with customer service agents, and/or identified evolved threats.

This comprehensive architecture may allow the anomaly detection system 100 to analyze user behavior, assess risk, and make real-time decisions to prevent anomalous activities (e.g., fraudulent activities) across the e-commerce platform. The interconnected components may work together to process user actions, evaluate risk, and implement appropriate anomaly prevention measures (e.g., fraud prevention measures) throughout the user's journey.

### Example Unified Application Interface

In some embodiments, the anomaly detection system may include a unified application interface that serves as a point of interaction between the anomaly detection system and various touchpoints of the e-commerce platform. This interface may be designed to integrate with multiple user touchpoints, potentially providing a consistent approach to anomaly detection across the user journey. The unified application interface may be capable of integration with various points in the user journey, which may include, but are not limited to, account creation, login attempts, password resets, payment method changes, shipping address updates, and/or order placements.

For each user action at an integrated touchpoint, the interface may collect relevant attributes. These attributes may include, for example, IP address, device ID, bot score (a probability that the user might be a bot), user action type, timestamp, user identifier (if available), and/or session information. Based on the collected attributes and the anomaly assessment (e.g., fraud assessment) performed by the system, the interface may return a decision for each user action. The possible decisions may include allowing the user action to proceed without additional verification, preventing the user action due to high anomaly risk (e.g., high fraud risk), or requiring additional verification before the user action can proceed.

The interface may provide an API that could be implemented by different teams within the e-commerce organization. This may simplify the process of adding anomaly protection (e.g., fraud protection) to new services or touchpoints as the platform evolves. The interface may be designed to provide decisions quickly, which may help minimize impact on user experience while maintaining security measures.

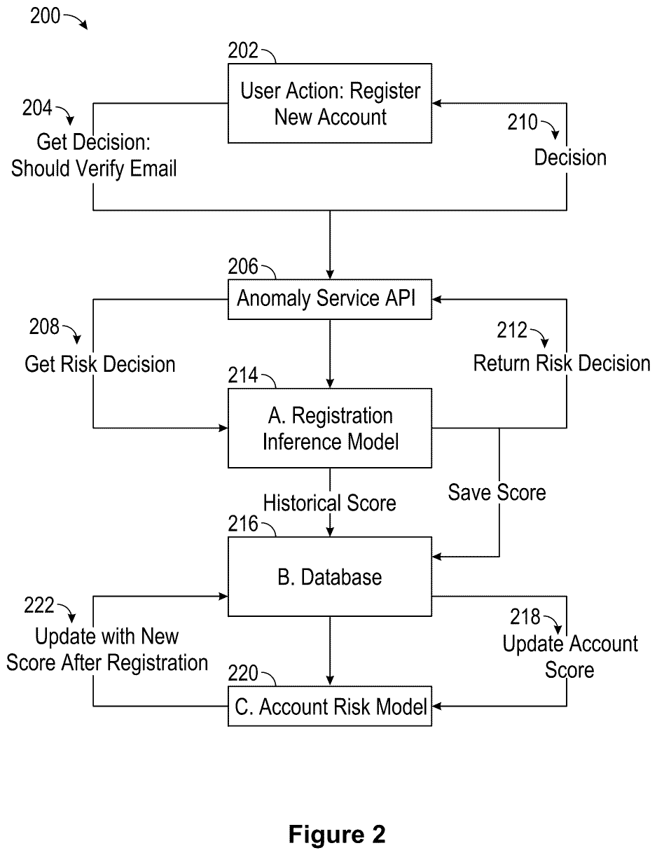

FIG. 2 is a schematic diagram of an implementation of an example anomaly as a service API 200, for an account registration process, according to some embodiments. This diagram illustrates how various components from FIGS. 1A and 1B interact during a new account registration event. The process may begin with a user action 202 to register a new account. This action may correspond to one of the touchpoints in the user journey 108. The action may trigger a “Get Decision: Should Verify Email? ” 204 query, which may be sent to an anomaly service API 206. This API may correspond to the API (enterprise anomaly service) 130, which may be an enterprise anomaly service in some embodiments. The anomaly service API 206 may send a “Get Risk Decision” 208 request to a registration inference model 214. The registration inference model 214 may send a return risk decision 212 to the anomaly service API 206. The anomaly service API 206 may then return a decision 210 regarding whether email verification is necessary. These decisions may be the result of the blocking rules engine 132 and/or business rules engine 134. The registration inference model 214 may be a part of the machine learning platform 146. This model may analyze the risk associated with the new account registration. The model may generate outputs that are sent to a database 216, which may correspond to the anomaly data warehouse 138 or the identity graphing database 140. The database 216 may then perform an update account score 218 action, sending this information to an account risk model 220. This account risk model may be one of the account protection models 148.

Finally, the account risk model 220 may update with a new score after registration 222, feeding this information back to the database 216. This feedback loop may contribute to the continuous updating of risk assessments as mentioned in the description of FIGS. 1A and 1B. This example workflow demonstrates how the anomaly as a service API can integrate various risk assessment models and databases to evaluate and update risk scores associated with new account registrations in real-time. The system 100 may use immediate risk assessments and/or historical data to make decisions about email verification and/or to update overall account risk scores, aligning with the comprehensive anomaly detection approach described above in reference to FIGS. 1A and 1B.

### Example Data Ingestion Pipeline

In some embodiments, the anomaly detection system may include a data ingestion pipeline. This pipeline may be responsible for capturing, processing, and storing data from integrated touchpoints across the e-commerce platform. The pipeline may be designed to ingest data from various sources across the e-commerce platform. This may include user interactions, transaction data, account modifications, and other relevant events that occur at integrated touchpoints.

As data is ingested, the data may be transformed into a standardized format that can be processed and analyzed by the system's components. This may involve processes such as data cleaning, normalization, or enrichment. The processed data may be stored in a centralized location, which may be referred to as an anomaly data lake. This data lake may serve as a repository of relevant data for fraud detection and analysis.

The pipeline may be designed to handle large volumes of data from multiple sources simultaneously, which may allow the pipeline to scale with the growth of the e-commerce platform. The pipeline may incorporate security measures to protect user data during ingestion, processing, and storage. The pipeline may also implement data minimization and purpose limitation principles to align with data privacy regulations. The pipeline may be capable of ingesting data from third-party sources to enrich the platform's data. This may include data from identity verification services, credit bureaus, or other relevant external sources. The pipeline may utilize an event-driven architecture, which may allow the pipeline to process data as the data arrives and trigger actions or analyses based on specific events or patterns in the data.

### Example Graphical Database

In some embodiments, the anomaly detection system may include a graphical database. This database structure may be designed to store and analyze relationships between various entities involved in e-commerce transactions. The database may link various entities such as user accounts, devices, IP addresses, transactions, and other relevant data points. These links may create a network of relationships that can be analyzed for potential anomaly patterns (e.g., fraud patterns).

The database may be updated with new data from the ingestion pipeline, which may help ensure that current information is available for anomaly analysis. The graphical structure may allow for querying of complex relationships, which may enable risk assessments and anomaly detection. By storing data as a graph, the system may be able to identify patterns of behavior across multiple accounts or transactions that could indicate potential anomaly schemes.

The graphical structure may aid in resolving user identities across different touchpoints and devices, which may help build a more complete picture of user behavior. The database may be designed to scale horizontally, which may allow the database to handle growing volumes of data as the e-commerce platform expands. The graphical nature of the database may allow for visualization of connections between entities, which may be useful for manual review of complex cases.

### Example Neural Network and Machine Learning Models

In some embodiments, the anomaly detection system may employ a neural network and multiple machine learning models to analyze data, assess risk, and make anomaly prevention decisions. The neural network may be associated with the graphical database and may be designed to analyze linked data to predict user identities and detect patterns that may indicate anomalous behavior. The neural network may provide risk assessments for user actions, use unsupervised learning techniques to identify potential new patterns of anomalous behavior, and adapt and adjust anomaly prediction models (e.g., fraud prediction models) based on outcomes of challenged or blocked actions.

The system may incorporate one or more machine learning models, which may include an account risk scoring model, a transaction risk scoring model, a returns risk scoring model, an account creation risk model, and/or a behavior anomaly detection model. These models may generate risk scores for user accounts, transactions, and/or return requests, assess the likelihood of potentially anomalous account creation attempts, and/or identify deviations from a user's established patterns of activity.

These models may work together in a structure where outputs from some models may serve as inputs to others. This approach may allow for a risk assessment that takes into account various aspects of user behavior and transaction characteristics. The machine learning models may be trained and updated using data from the anomaly data lake, which may allow them to adapt to new patterns and evolving behaviors. The system may also employ a feature store to manage and serve pre-computed features to the various models. For the neural network and machine learning model algorithms, the system may employ a multi-layer perceptron neural network for user identity prediction, using ReLU activation in hidden layers and SoftMax in the output layer. For transaction risk scoring, an XGBoost classifier may be used, with feature importance analysis to understand key risk factors. The user identity prediction process may include several steps. The system may extract relevant features from user behavior data, create dense vector representations of user activities, compute cosine similarity between the current user embedding and known user embeddings, and/or assign the identity with the highest similarity above a set threshold

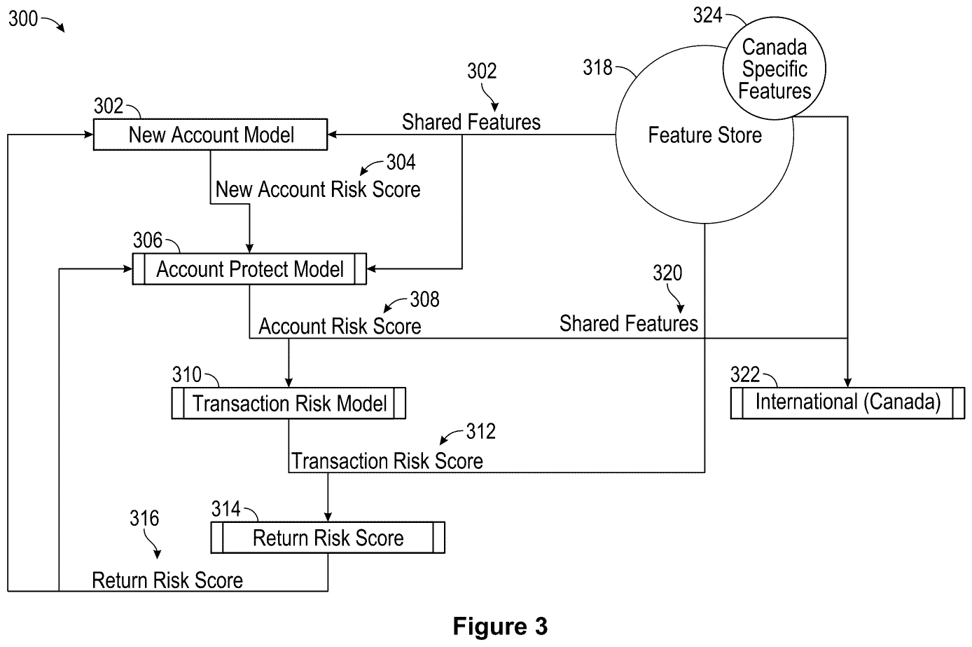

FIG. 3 is a schematic diagram of an example machine learning model hierarchy 300 for a anomaly detection system (e.g., the system 100), according to some embodiments. The diagram depicts the relationships and data flow between various risk assessment models and a feature store. The hierarchy may begin with a new account model 302, which may generate a new account risk score 304. This score may feed into an account protect model 306, which may correspond to the account protect models 148 from FIG. 1B. The account protect model 306 may generate an account risk score 308, which may then be used as an input for a transaction risk model 310. This model may align with the transaction risk model 150 from FIG. 1B. The transaction risk model 310 may produce a transaction risk score 312, which may serve as an input for a return risk score model 314. This model may correspond to the return risk calculation risk model 152 from FIG. 1B. The return risk score model 314 may generate a return risk score 316, which may be fed back to both the new account model 302 and the account protect model 306, creating a feedback loop within the system.

A feature store 318 may be included in this hierarchy, providing shared features 320 to multiple models. The feature store 318 may supply shared features to the new account model 302, account protect model 306, and/or transaction risk model 310. The model hierarchy may also include an international model 322, which may receive input from both the feature store 318 and a separate set of country-specific features 324. This may demonstrate how the system may accommodate region-specific models and features.

This example model hierarchy illustrates the interconnected nature of the anomaly detection system, where outputs from one model may serve as inputs to others, and how a centralized feature store may support multiple models with shared and/or region-specific features. The system may allow for a comprehensive risk assessment that may consider various aspects of user behavior and transactions throughout the user journey.

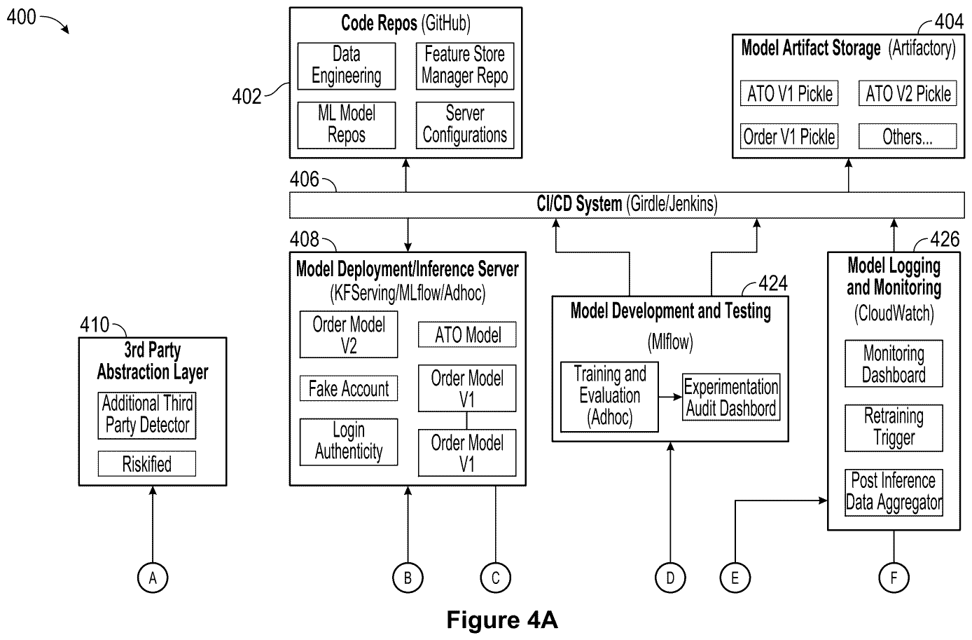

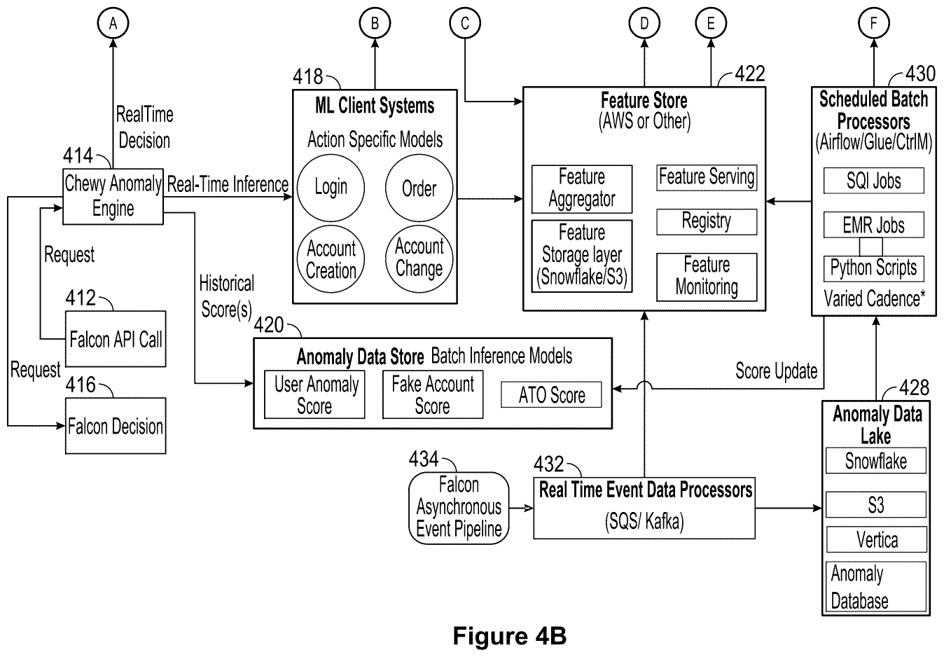

FIGS. 4A and 4B are schematic diagrams of an example machine learning infrastructure 400 of a anomaly detection system, according to some embodiments. This diagram expands on the components and processes shown and described above in reference to FIGS. 1A, 1B, 2, and 3, providing a more detailed view of how the various parts of the system interact.

The infrastructure may include two repositories: code repos 402 (e.g., hosted on GitHub) and model artifact storage 404 (e.g., using Artifactory). The code repos 402 may include data engineering, feature store manager repo, machine learning model repos, and/or server configurations. The model artifact storage 404 may include serialized versions of account takeover detection models, order risk assessment model, and other machine learning model artifacts. A continuous integration/continuous deployment (CI/CD) system 406 (e.g., using Girdle/Jenkins) may connect these repositories to the rest of the infrastructure, facilitating continuous integration and deployment.

A model deployment/inference server 408 (e.g., using KFServing, MLflow, and/or Adhoc) may host various models, including different versions of order model, ATO model, fake account, and/or login authenticity. This server may correspond to the machine learning platform 146 in FIG. 1B. The infrastructure may include a third party abstraction layer 410, which may include an additional third party detector and/or Riskified. This layer may relate to the external data sources 186 in FIG. 1B. An anomaly engine 414 (e.g., a fraud engine 414) may orchestrate the decision making process. An API call 412, which may correspond to the anomaly service API 206, may send requests to the anomaly engine 414, and the anomaly engine 414 may provide a response to a decision module 416. For real-time decisions, the anomaly engine 414 may interface with the third-party abstraction layer 410. The anomaly engine may interface with machine learning client systems 418 for real-time inference. The machine learning client systems 418 may include action specific models for login, order, account creation, and/or account change. These models may align with the various touchpoints in the user journey 108.

The anomaly engine 414 may provide historical scores to a anomaly data store 420. The anomaly data store 420 may include batch inference models for user anomaly score, fake account score, and/or ATO score. This may relate to the anomaly data warehouse 138 described above in reference to FIG. 1A. A feature store 422 (using AWS or other services) may be included, which may correspond to the feature store 318 in FIG. 3. The feature store may include components for feature serving, feature aggregator, feature storage layer, registry, and/or feature monitoring.

The infrastructure may also include model development and testing 424 (e.g., using MLflow), which may include training and evaluation, and/or experimentation audit dashboard components. The infrastructure may also include a model logging and monitoring 426 (e.g., using CloudWatch), which may include a monitoring dashboard and/or retraining trigger, which may relate to the continuous updating of risk assessments mentioned in FIG. 2. model logging and monitoring 426 may also include a post-inference data aggregator. The infrastructure may also include a anomaly data lake 428 (e.g., using Snowflake, S3, Vertica, and/or a anomaly database) and scheduled batch processors 430 (e.g., using Airflow/Glue/CRON), which may include SQL jobs, EMR jobs, and Python scripts. The infrastructure may also include a real time event data processors 432 (e.g., using SQS/Kafka) connecting to various components, which may relate to the real-time data processing capabilities of the system 100. The rea-time event data processors 432 may obtain events from an asynchronous event pipeline 434. The example infrastructure illustrates how the various components of the anomaly detection system 100 may work together to process data, train models, make real-time decisions, and/or continuously improve the system's anomaly detection capabilities.

### Example Anomaly Orchestration System

In some embodiments, the anomaly detection system 100 may include a anomaly orchestration system (sometimes referred to as the anomaly engine, e.g., the anomaly engine 414). This component may integrate inputs from various sources, apply rules and risk assessments, and determine appropriate anomaly prevention actions for user actions. The system may receive risk assessments from the neural network and risk scores from the various machine learning models, potentially combining these inputs to form a risk profile for each user action.

A set of rules may be applied to the risk assessments and scores. These rules may be created, modified, or removed, potentially allowing for adaptation to new anomaly patterns or business requirements. For example, the rules may be modified based on analysis of false decline rate versus anomaly capture rate. Based on the applied rules and risk assessments, the system may implement anomaly prevention actions, which may include potentially preventing the user action from proceeding due to high anomaly risk, potentially permitting the user action to proceed without additional verification, or potentially requiring additional verification before the user action can proceed.

The system may adjust the level of authentication required based on risk scores and the specific action being performed. This may allow for a balance between security and user experience. For actions deemed potentially risky, the system may implement additional security measures. This might involve progressively more stringent verification methods as risk increases. The system may be capable of routing high-risk actions to additional verification services when necessary. This might include services for identity verification, device fingerprinting, or behavioral biometrics.

For complex decisions, the system may aggregate and reconcile decisions from multiple anomaly prevention services. The orchestration system may operate quickly, potentially providing rapid decisions to maintain user experience while implementing anomaly prevention measures. The system may update risk assessments based on ongoing user interactions, potentially recalculating risk scores and adjusting anomaly prevention actions as needed. The orchestration system may be designed to adapt to new services or verticals added to the e-commerce platform. The orchestration system may be capable of integrating with new touchpoints and updating its rule set to include anomaly prevention strategies for new services. The dynamic rules within the anomaly orchestration system may be created based on patterns identified by machine learning models. These rules may undergo periodic reviews for effectiveness, with updates triggered as needed. The system may apply these rules hierarchically, with more specific rules taking precedence over general ones.

### Example Anomaly Detection System

The anomaly detection system 100 may help protect an e-commerce platform throughout a user's journey 108 and may comprise several components. A unified application interface, which may be part of the enterprise anomaly service 130, may integrate with multiple user touchpoints, receive attributes associated with each touchpoint, and/or return decisions to block, allow, or challenge user actions. The touchpoints along the user's e-commerce journey may include, for example, account creation, login, profile updates, and transactions. In some embodiments, the attributes may include internet protocol (IP) address, device identifier (e.g., for the device used for the user action), bot score (a probability that the user is a bot), and/or user action. In some embodiments, the attributes are received for each touchpoint. In some embodiments, at least one of the attributes is received for each touchpoint. A user action may correspond to a user performing an action (e.g., sign up, log in, buy something). A touchpoint may correspond to an integration between the user interface, where the user performs an action, and the anomaly service or system.

The system 100 may include a data ingestion pipeline to capture and/or process real-time data from integrated touchpoints, transforming and storing the data in a anomaly data warehouse 138. An integrated touchpoint may be a point of user interaction within the e-commerce platform that has been connected to the anomaly detection system via a unified application interface. This connection may allow for data collection and/or application of anomaly prevention measures at that specific point in the user's journey. Because the data may be different across systems in an e-commerce website, the system 100 may include a data lake where all data may be contained. Then the system 100 may use the data lake to derive attributes and features that may be needed for the machine learning models.

The system 100 may utilize a graphical database, which may be part of the identity graphing database 140, to link user interactions, devices, accounts, and transactions across the platform, updating with new data from the pipeline. In some embodiments, the update may be continuous and/or occur in real-time (e.g., within seconds). User interactions may include user actions, but the system may not integrate with each part of the users interactions. For example, a user can click around the product description pages, and while the system may ingest and monitor this data and may even use this data in the machine learning models, the system may not count these as user actions. A user action may include a user performing an action that involves creating or modifying a user account. This may include, but is not limited to, sign up, log in, changing the password, adding or deleting a payment method, adding, or deleting an address, creating a new order, creating a new return, and so on. A touchpoint may refer to any user action where the anomaly service (sometimes referred to as the system) is integrated and can perform blocking and/or challenging actions.

A neural network associated with the database may analyze linked data to predict user identities and detect anomalous behavior patterns, providing real-time (e.g., under one minute; e.g., under 500 milliseconds latency) risk assessments for each action. In some embodiments, the neural network may include conventional networks and/or may include cloud-based service (e.g., Amazon Web Services that is part of Neptune, without modification). Some embodiments use third party solutions (e.g., Neo4j). Some embodiments use Neptune's graph neural network machine learning model. The models may be continuously trained using conventional methods. Some embodiments provide a risk score for a touchpoint, which corresponds with a user action. While there may be a risk score associated with every touchpoint, the system 100 may provide the ability to score users based on where risks may be originating (e.g., starting with a user journey on an e-commerce website or platform), which may use the IP address, activity and/or navigation, behavior in the browser (e.g., copying and pasting), behavior of the device (e.g., windows opening and closing, background/foreground switching), and/or device fingerprint (e.g., unique identifier for this person).

The system 100 may include a plurality of machine learning models within the machine learning platform 146, such as account protect models 148 and transaction risk model 150, which may use data from the anomaly data warehouse 138 and/or neural network predictions to generate risk scores. The machine learning models may include XGboost and/or autoencoder neural networks. AWS Sagemaker may be used to train one or more machine learning models on data generated from an internal database enriched with external data sources, such as IP intelligence, for a specific time period. The risk scores may correspond to user accounts and/or individual transactions. A transaction may include, for example, selling of goods, transfer of monetary value, which may be referred to as an order. A user action may include, for example, signing up for an account at an e-commerce website.

For training data, some embodiments use a third-party database to obtain the latitude and longitude of an IP address along with the identity of the Internet Service Provider (ISP). Some embodiments determine if a connection is using a proxy or VPN. Some embodiments may use these latitudes and longitudes directly as features. Some embodiments may convert billing or shipping zip codes to latitude and longitude to perform distance measurements. Some embodiments may obtain data from a database (e.g., zip codes of shipping address), preprocess the data (e.g., convert the data to latitude/longitude), and/or process the final feature as a distance between two sets of latitude/longitude values. Some embodiments may use information on whether an order is anomalous to create features. This may be a value that is obtained from a database. Some embodiments may look up attributes in the database about an order, such as the shipping address, to determine if a current order's shipping address corresponds to any anomalous orders.

Examples of features used to train the machine learning models and the process for obtaining the features are described herein, according to some embodiments. Some embodiments may determine if an IP address has been used by a customer before. Some embodiments may query a database for IP addresses previously used by the customer, and/or may set it to a predetermined value (e.g., a value of 1) if the IP address has been previously used. Some embodiments may calculate and use Z-score of order total value. Some embodiments may query previous orders in the previous months (e.g., last 6 months), calculate the standard deviation and mean, and/or use the standard deviation and mean to calculate the z-score associated with the current order total. Some embodiments may use a count of customers using a same device. For example, the system may use a device identifier obtained at time of login and count the number of customers using the same device based on the device identifier. The device identifier may be obtained from third party devices (e.g., fingerprint pro) and/or may be obtained directly from the device.

For the training features, some embodiments may calculate a name match score between shipping and billing (e.g., calculate a similarity score between name on a billing address and name on a shipping address, using techniques such as Levenshtein distance or Jaro-Winkler similarity). Some embodiments may calculate a count of addresses added in the previous days (e.g., last 7 days). For example, the system may count the number of new shipping addresses the customer may have added to their address book in the last 7 days. Some embodiments may use the previous order count. For example, the system may use the count of orders a customer may have placed in the last 12 hours, with higher frequency potentially indicating suspicious activity. Some embodiments may determine if an international device is used. For example, using a device information, the system may determine if the time zone of the device corresponds to a US or international time zone, which may be indicative of potentially anomalous activity. Some embodiments may use a return ratio in a previous time period (e.g., past 6 months). For example, the system may determine the percentage of orders from a customer in a previous time period (e.g., last 6 months) that have a return associated with them. Some embodiments may use the number of canceled auto-ships or auto-ship subscriptions in a previous time period (e.g., last 6 months). Some embodiments may use a combination of the features, a subset of the features, or a superset of the features. The selection and/or combination of the features may be dynamically adjusted based on their predictive power. For example, the count of addresses in past 7 days may be used only in the account model. The return ratio may be used by the return model. The features related to order history may be used only by the order model. Features related to customers sharing a device may be used by all models. Returns, accounts, and/or orders that are not anomalous may be down-sampled. The system may maintain between a 10:1 and 30:1 ratio of not-fraud to fraud, which is typically higher than the real population, which may help improve model sensitivity to anomalous cases while maintaining overall accuracy.

The system 100 may include an anomaly orchestrator 144, which may receive risk assessments and scores, applying dynamic rules from the blocking rules engine 132 and business rules engine 134 to implement anomaly prevention actions for user action. For example, suppose a return contains a specific SKU item, that is considered higher risk, the system may consider the return to be high-risk. Higher risk may be indicated by the return ratio of the SKU being outside the standard deviation of returns for that SKU (e.g., based on returns in a previous time period, e.g., 90 days). As another example, suppose a customer has a specific buying pattern of a predetermined number of orders person day/week/month for a previous 2.5 years of history with an e-commerce platform. Suppose, subsequently the customer orders the predetermined number times 2.5 at that normal velocity, the system may begin to block orders after the order is above their normal amount. The rules may be dynamic because the rules can be modified hourly, daily, weekly, and/or monthly. The rules may also be dynamic because the rules can be configured based on each individual user and their behavior. For example, there may be a velocity rule ‘if the user places 2×(user average order number per day over the trailing 6 months) then block the order’. The average may be constantly changing, because the trailing 6 months is constantly changing, as well as the user behavior.

In some embodiments, the system 100 provides a model hierarchy 300 as shown in FIG. 3. The machine learning models may include a return risk score model 314 (sometimes referred to as a refund risk model). The account protect model 306 (sometimes referred to as the account risk scoring model) may generate scores (e.g., an account risk score) for each user account and use transaction and return risk scores (sometimes referred to as refund risk scores) as features in subsequent calculations of account risk scores. The transaction risk model 310 (sometimes referred to as the transaction risk scoring model) may use the account risk score 308 to generate transaction risk scores 312 (e.g., for each transaction, for some of the transactions). The return risk score model 314 may use both account risk scores and transaction risk scores to generate return risk scores 316 for each request. The cyclic dependency between the models may allow for continuous refinement of risk assessments based on the most recent user activities, more accurate anomaly detection by considering the interrelationships between account behavior, transaction patterns, and return requests, and/or a holistic view of user risk across different aspects of the e-commerce journey. The outputs from one model may be used as inputs for another, including, but not limited to, weighting and/or prioritization. For example, a model at the account level may utilize the score of recent orders from an order model, as a feature. When the order model has a high-risk score on an order, the feature may cause the account model to have a higher risk score. When the order model ascribes low risk, the account model is more likely to have a lower risk.

In some embodiments, the system 100 provides specialized risk models. These may include a new account model 302 (sometimes referred to as an account creation risk model) to assess anomalous account creation attempts, and/or a behavior anomaly detection model to identify deviations from established user activity patterns. The specialized models may include a first model based on XGboost, which may be trained using one or more of the following features: a number of times a customer has used that payment method, account age, z-score between current cart total and historic transaction average for that customer, days since last purchase, AVS for payment method, distance between shipping, billing, and IP address. A second specialized risk model may be based on XGboost, which may be trained using one or more of the following features: number of accounts with same payment token, geolocation of login, recent email changes, recent shipping addresses added, and/or number of accounts with same device identifier (ID). Another model may be based on autoencoder neural network, which may be trained using similar features described above in reference to the second model. Another specialized risk model may be based on XGboost, which may be trained using one or more of the following features: login success/failure counts, password reset success/failure counts, count of payment methods added recently, changes to auto-ship subscriptions, and/or if a new IP address is associated with account. Yet another specialized risk model may be based on XGboost and may be trained using one or more of the following features: maximum recent score from the first specialized risk model, count of recent returns, total value of recent returns, number of customers linked to the IP address used for chat, and/or number of returns that have been validated.

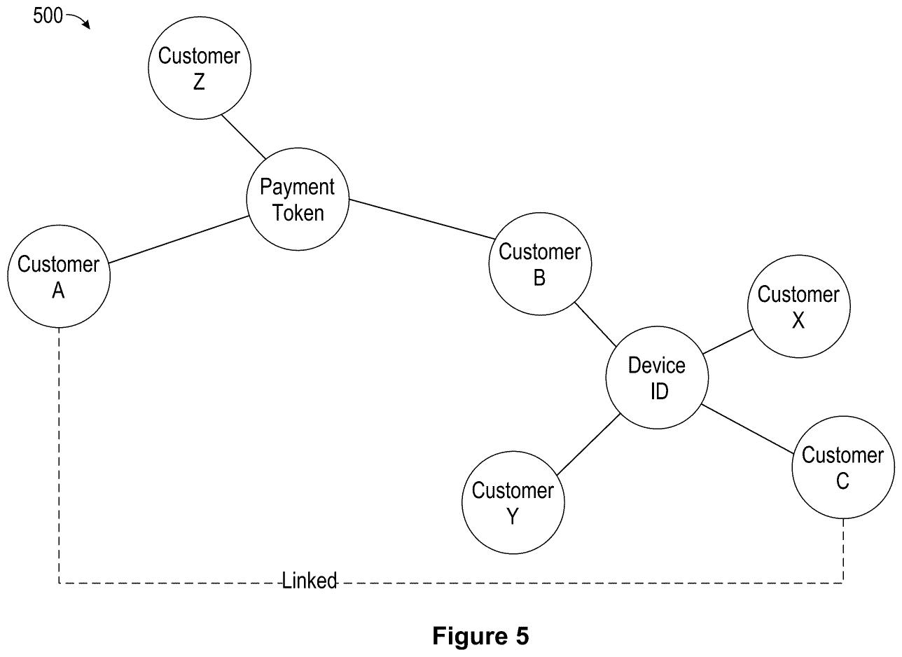

In some embodiments, the system 100 provides connection mapping. The identity graphing database 140 may establish connections between seemingly unrelated accounts based on shared attributes and provide visual representations for manual review in complex cases. FIG. 5 is an example visual representation 500 provided by the identity graphing database, according to some embodiments. Customer A and customer B may be linked via payment token. Customer B and customer C may be linked via device ID. Using the graph network, the system may connect customer A, customer B, and customer C.

In some embodiments, the system 100 provides early-stage anomaly detection and prevention. The system 100 may detect and prevent anomalous activities at the earliest possible stage, including account creation, by analyzing attributes (e.g., attributes received by the unified application interface during account creation, including IP address, Device ID, and user action patterns), comparing the attributes against known anomalous patterns (e.g., patterns stored in the graphical database), generating initial risk scores (e.g., using the account risk scoring model, for a new account), and triggering prevention actions if necessary. For example, the system may trigger the anomaly orchestration system to block or challenge the account creation if the risk score exceeds a predetermined threshold. These operations may enable the system 100 to identify and/or mitigate potential anomaly before a user account is fully established on the e-commerce platform. Some embodiments determine the threshold based on historical data (e.g., three months of data) and applying possible thresholds and outputting the precision and recall. Precision corresponds to the percentage of customers challenged, who would have been bad actors (e.g., fraudsters). Recall corresponds to the percentage of anomalies that occurred during a time window that may be caught with the challenges. Some embodiments select the optimal threshold that has the best precision and recall.

In some embodiments, the system 100 provides dynamic authentication and security measures. The anomaly orchestrator 144 may adjust authentication levels based on risk scores and specific actions, implementing gradual security step-ups for increasingly risky actions to balance user experience with anomaly prevention. Described herein is an example of step up in actions, according to some embodiments. Suppose a user logs into an account they own. This may cause no friction and/or checks. Suppose a fraudster logs into the same account from a new simulated device and/or risky IP address. The system may throw an MFA challenge, and the fraudster cannot pass and/or may be blocked from accessing the account. Further suppose the fraudster then attempts to log into a different users account with a new simulated device but with the same IP address. The user may be thrown a MFA challenge and again cannot access the account. Subsequently, let us say the fraudster then attempts to log into a different users account with a new simulated device but same IP address. The system may now know that this IP address is highly risky, so the system may block the IP address from accessing the e-commerce website or platform at the edge. The fraudster is prevented from even getting to the login page. In some embodiments, when a user continues to interact with a web site, the system may perform the following escalations as the risk score increases: (1) initial risk score is low - do nothing; (2) risk increases based on security signal indicating bot - throw a ReCAPTCHA; (3) risk score continues further - throw an MFA; and (4) risk score is severely elevated - block traffic altogether. In some embodiments, this gradual step-up in security measures may begin with basic authentication using username and password, escalate to two-factor authentication with an SMS code, then move to biometric verification like fingerprint or facial recognition, and finally resort to manual review by an anomaly analyst (e.g., fraud analyst) for the highest risk cases.

In some embodiments, the system 100 provides routing of high-risk actions to third-party services. The anomaly orchestrator 144 may route high-risk actions to additional verification services when necessary, potentially utilizing external data sources 186. Additional verification may be performed in several ways. For example, for the riskiest customers, they may be required to call customer service and will be sent a code (e.g., a 6-digit code) that they must read aloud to the customer service agent on the phone, confirming they have access to either the phone number or email on the account. The moderate risk may be required to call customer support and answer a series of security questions confirming the customer's identity. These questions may be related to account information (e.g., last 4 digits of card used in previous transaction, shipping address from previous orders). For the least risky customers, they may simply confirm their identity by clicking a button within the email notification they receive after their order is ‘blocked’ (e.g., shipment is not allowed until identity is confirmed). Any specific risk threshold that may be set can trigger routing to more verification. Some embodiments use risk thresholds to trigger the routing. Some embodiments may also use specific characteristics of an order for triggering the routing. For example, electronic gift card purchase may trigger an MFA.

In some embodiments, the system 100 provides integration across multiple touchpoints. The unified interface may integrate with additional touchpoints in the user journey 108 like password reset requests, payment changes and/or shipping address updates, and/or assign different risk thresholds for each touchpoints based on potential anomaly impact at that stage of the user journey. Described herein are examples for how this potential impact may be predicted or assigned for each stage. Suppose there are three stages. This example shows how the system may assign different thresholds. Example scoring of 0 -100 where 0 is ‘no risk’ and is ‘extremely risky’ is used for the sake of illustration (different scoring methods or thresholds may be used). The score may be calculated using a machine learning model that uses features based on users'most recent behavior and historical behavior. The score may be updated every time a user takes significant action on an account and/or at periodic intervals (e.g., every hour). The scores may be assigned to each user and/or order or return, and/or stored in the anomaly data lake for retrieval in real-time. The scores may change, but the thresholds may be stored in the database for each touchpoint.
Stage 1a ‘Sign up’: This may correspond to a higher threshold (e.g., score is greater than 98.9, risky) and lower tolerance for challenging (e.g., enforcing email verification to complete sign up) when users are creating accounts because at this stage in the user journey there is no payment methods, addresses, or transactions on the account. The system may determine not to impact potential good new customers.
Stage 1b: ‘Login in’: This may correspond to a slightly lower threshold, but still high (e.g., score is greater than 60) tolerance for challenging logins (e.g., making the user perform multifactor authentication) when users are logging into an account. At this stage, it is riskier, because an account can hold a customer's PII information (e.g., physical address, name, email, etc.) and the user has access to user payment methods to buy goods at the e-commerce website or platform.
Stage 2: ‘Adding a new address’: This may correspond to a slightly lower threshold, but moderate (e.g., score is greater than 50) tolerance for challenging adding a new address (e.g., making the user perform multifactor authentication) when users add an address. At this stage it is riskier, because if a new address is added, the fraudster could potentially use a customer's payment method to ship to this new address.
Stage 3: ‘Creating an order’: This may correspond to a slightly higher threshold, but moderate (e.g., score is greater than 70 to elevated risk, greater than 90 to decline) tolerance for challenging (e.g., making the user perform multifactor authentication) or declining (‘automatically blocking and cancelling the order’) an order. At this stage it is riskier, because it could cause monetary loss to the customer, and/or cause monetary loss to the e-commerce platform.

In some embodiments, the system 100 provides comprehensive user behavior profiling. The data ingestion pipeline may create user behavior profiles by processing and/or correlating data from multiple touchpoints in the user journey 108, and identify and/or flag sudden changes for immediate risk assessment (e.g., based on the user behavior profile).

In some embodiments, the system 100 provides evolving user risk profiles. The system 100 may generate and/or maintain risk profiles that evolve throughout the user journey 108, and/or inform decisions at each subsequent touchpoint (e.g., use the risk profile to inform decisions at each subsequent touchpoint, providing a seamless and adaptive anomaly prevention experience).

In some embodiments, the system 100 provides account takeover prevention. The system 100 may detect and prevent account takeover attempts by analyzing login patterns, device changes, and/or account activity, and/or implement verification steps for high-risk account changes, such as password resets or email address updates. The system, may for example, perform, gather and/or analyze data from manual or automated analysis to determine potential vulnerabilities in the user journey from registration to order creation. An example of using manual analysis is described herein, according to some embodiments. Suppose the system sees an uptick in anomalies (e.g., fraud) related to auto-ship (subscription based) orders. The system knows that subscription orders are driven by the system on specific dates set by the user. The system may then determine that the auto-ship orders are shipping to new addresses on the many accounts in which the system sees fraud during this increase in fraud. The system may then take each order and confirm there was an MFA challenge when the address was added. The system can see that none of the new addresses triggered an MFA verification step. The system may report the ‘bug’ to the auto-ship team and/or system, and the system and/or personnel can fix the bug and restore the system.

In some embodiments, the system 100 provides unsupervised learning and real-time model adjustment. The neural network may identify new anomalous behavior patterns and adjust prediction models in real-time based on outcomes. The system 100 may use unsupervised learning techniques to identify new, previously unknown patterns of anomalous behavior, and/or adjust anomaly prediction models in real-time based on outcomes of challenged or blocked actions. Some embodiments use neural networks and/or unsupervised models to detect graphical linking across accounts, using device identifier, payment identifier, shipping address, billing address, IP address, and/or phone number. The unsupervised learning techniques may include K-means clustering to identify unusual behavior patterns, Isolation Forest algorithm for detecting outliers in user actions, t-SNE for visualizing high-dimensional user behavior data, and/or the Apriori algorithm to discover relationships between different user actions.

In some embodiments, the system 100 may further include a rules engine for dynamic rule creation and modification. This engine, which may be part of the blocking rules engine 132 or business rules engine 134, may allow rule changes without system downtime and suggest new rules based on identified patterns. The rules engine may allow for the creation and modification of anomaly detection rules without requiring system downtime, and/or automatically suggest new rules based on patterns identified by the neural network and machine learning models.

In some embodiments, the system 100 provides adaptive anomaly prevention routing. The anomaly orchestrator 144 may dynamically route actions to different services (e.g., fraud prevention services) based on characteristics and risk assessment, aggregating and/or reconciling decisions (e.g., decision from multiple fraud prevention services) when necessary. For example, suppose a user is logging in. The system may route this decision to account risk models (e.g., three models). One model may look at real-time events and provides a score, one model may look at historical score based on account takeover risk signals, and another model may look at historical score based on policy abuse risk signals. Together the models may return a combined risk score and decision on whether to challenge the use. As another example, suppose a user is creating an order in which he purchases an electronic gift card. The system may route this to the transaction risk model. Within this model, there may be different smaller “micro” models, and the system may receive two scores for this order. The first score may be scored by a ‘general transaction risk model’ which scores every single transaction. The second score may be scored by an ‘electronic goods risk model’, which scores only transactions that contain electronic goods. Those scores may be combined, and the system may provide a combined risk score and decision for this transaction. Described herein is an example of an electronic gift card order. The example uses a risk score of 0-1, whereby 0 is little to no risk and 1 is the riskiest an order can be. The order may receive the following scores from model A (general) and model B (micro): model A. general transaction risk model: 0.67 (moderate risk); and model B. electronic gift card risk model: 0.97 (extreme risk). The system may then use the higher risk score, which in this case is 0.97. The order may be declined and/or canceled. In some embodiments, the micro models may use an average of the two scores, or the lower of the two scores.

As another example, suppose a user is creating an order in which he purchases hard goods. The system may route this to the transaction risk model. Within this model, there may be different smaller “micro” models, but because this order does not fit the criteria for any of the specialized models, the system may score by the ‘general transaction risk model’ which may score each transaction, and the system may use this risk score and decision for this transaction. As another example, suppose a user is initiating a return for a previous order. For this scenario, the system may route this to the returns risk model. There may be one model for return risk, so the system may simply score the return and send a decision based on that score.

In some embodiments, the system 100 provides continuous risk assessment updates. The system 100 may continuously update assessments by processing real-time data, refining user profiles, re-analyzing data, recalculating risk scores, and adjusting prevention actions accordingly. For example, the system 100 may capture and process real-time data from each user interaction through the data ingestion pipeline, update the graphical database with new interaction data to refine the user's behavioral profile, re-analyze the updated data using the neural network to detect any new patterns indicative of anomalous behavior, recalculating risk scores using the machine learning models after each significant user action or at regular intervals, and/or adjust the fraud prevention actions taken by the anomaly orchestration system based on the recalculated risk scores. The capturing, updating, re-analyzing, recalculating and adjusting operations may enable the system to maintain an up-to-date risk profile for each user and quickly respond to any changes in user behavior that may indicate anomalous activity. A significant user action may be anytime either (i) PII data in the account (PII being email, address, payment method, physical address, etc. that contain personal information to the customer) or (ii) a transaction, defined as a transfer of money (e.g., order, return, etc.), happens on the website or platform. The score may be updated when a user takes significant action on an account, and/or at predetermined time intervals (e.g., every hour).

Described herein is an example using the account risk model for recalculating risk scores, according to some embodiments. Example scoring of 0 -100 where 0 is ‘no risk’ and 100 is ‘extremely risky is used for illustration (other scoring methods and/or thresholds are possible). First, suppose a user logins to their account from a known device, the risk score is only 20. Suppose further that the user logins the next day from a new device, after the login event, the model recalculates the score because it determines this is riskier, the score is now 45. The user may try to add a new payment method, and the payment method is declined by the bank for reason “Fraud.” The model may recalculate again, and the score is now much higher and riskier. The score is now 89. Suppose next the user tries to add a second new payment method, and the payment method is again declined by the bank for reason “Fraud,” the model recalculates again, and the score is now much higher and riskier. The score is now 96. Next, the user tries to add a third new payment method, and the payment method is successfully added. The model may recalculate again, and the score is still elevated but drops slightly. The score is now 88. The user may then go to create a purchase. The risk score is below 90 threshold cutoffs to outright decline the order but is still above a 70-threshold cutoff to high-risk the order, so the order may be ‘blocked’, and the user may need to call customer service to verify their identity.

In some embodiments, the system 100 provides dynamic adaptation to new services and/or verticals added to the e-commerce platform. The system 100 may adapt to new platform additions by integrating with new touchpoints in the user journey 108, updating data processing, extending the database schema, retraining models in the machine learning platform 146, and/or updating anomaly prevention strategies. In some embodiments, the system 100 may configure the unified application interface to automatically integrate with new touchpoints introduced by added services or verticals, update the data ingestion pipeline to capture and process data specific to the added services or verticals, extend the graphical database schema to accommodate new types of user interactions and relationships relevant to the added services, retrain the neural network and machine learning models to recognize patterns and assess risks within the context of the new services, and/or update the anomaly orchestration system's rule set to include anomaly prevention strategies tailored to the specific risks associated with the new services or verticals. The configuring, updating, extending, retraining, and/or updating operations enable the system to seamlessly incorporate new services into anomaly detection and prevention framework without compromising effectiveness or requiring significant downtime.

For adding services or vertical, some embodiments provide a simplified lean anomaly API that any front end or back-end service can easily integrate with. In some embodiments, only two attributes may be needed to get a decision. An example API call may include a user interface API call which in turn includes a user ID or email address, and type of risk score needed (e.g., ‘Account,’ ‘Transaction,’ or ‘Return’). The API may return the following: customer ID or email address passed in the original call, a risk decision (‘No Risk,’ ‘Low Risk,’ ‘Moderate Risk,’ ‘High Risk,’ ‘Critical Risk’), and/or a reason for risk decision (i.e., ‘Return abuse risk,’ ‘ATO Risk,’ ‘Suspicious Account Activity,’ etc.).

In some embodiments, the system 100 provides reduced friction for legitimate users while maintaining heightened security against potential bad actors (e.g., fraudsters). The system 100 may establish behavior baselines, compare actions against these baselines, implement tiered authentication, and/or continuously refine risk profiles to distinguish between legitimate and anomalous activities. The system 100 may utilize the neural network and machine learning models to establish a baseline of normal behavior for each user, compare each user action against the personalized baseline to identify deviations, and/or implement a tiered authentication system within the anomaly orchestration system. For example, the level of authentication required may be dynamically adjusted based on the current risk assessment, allowing low-risk actions to proceed with minimal intervention, while applying additional security measures only to high-risk actions. The system may continuously refine the user's risk profile to more accurately distinguish between legitimate and potentially anomalous activities. The utilizing, comparing, implementing, allowing low-risk actions and continuously refining operations enable the system to minimize disruptions for legitimate users during their e-commerce journey while still maintaining robust anomaly prevention capabilities. In some embodiments, the system may not use the neural network to establish a baseline of user activity. Some embodiments use historical interactions, addresses, transactions, and/or returns, to establish a baseline of user activity. Some embodiments use historical data (e.g., one year of history) to establish a baseline. Because new users may not have that history, some embodiments may treat new users to be riskier when compared to other users. In some embodiments, as more data becomes available, the system may reduce the importance of historical data when assessing the risk. Some embodiments use the neural network to identify graphical links across accounts, transactions, payment methods, IP, and/or device, which may be specifically tied to confirmed anomalous activity.

In some embodiments, the system 100 may further include a feature store 318 as shown in FIG. 3. This store may maintain pre-computed features from historical data and provide the features in real-time to models for faster, more accurate assessments. The pre-computed features may be updated periodically (e.g., daily). The precomputed features may correspond to order history for a specific customer. Features may be grouped by weeks: e.g., 4, 8, 26 weeks, and values may include: total order count, total order value, average order value, minimum order value, maximum order value, and/or variance of order value. For example, the pre-computed feature may include the average order value for a customer in the past 8 weeks.

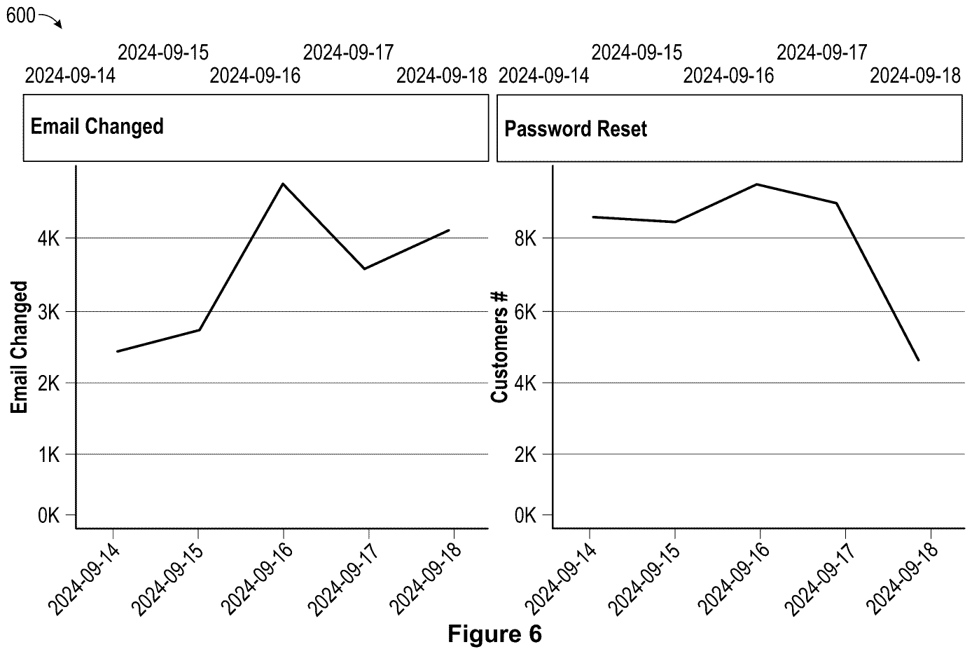

In some embodiments, the system 100 may further include a reporting and analytics module. This module may provide real-time dashboards and generate detailed reports on anomaly patterns and prevention effectiveness. Some embodiments may monitor a wide variety of events related to anomaly and our service touchpoints. FIG. 6 shows an example dashboard 600 for monitoring email change and password reset activity by date, according to some embodiments. Some embodiments include specific thresholds and monitors that will trigger if an anomaly is detected.

In some embodiments, the system 100 provides third-party integration and compliance. The system 100 may integrate with external data sources 186 to enrich user data and maintain compliance with privacy regulations. Some embodiments integrate with several third parties to enrich our data. An example of key attributes received from a third party related to IP data enrichment include: the latitude and longitude of the IP, is the IP address using a proxy or VPN, the internet service provider, and is the IP address anonymous. The anomaly service may ingest data from across the e-commerce platform. To maintain purpose limitation principles, the system 100 may not store all the data ingested. An example of maintaining this principle is: event in which a payment method is added to an account may be ingested. That event may contains PII information, and information specific to the payment method. But the system may not receive or store the PII information, but rather use a tokenization of the payment method. The system may store information such as the issuer response (e.g., card declined for fraud), relate and/or aggregate the token and issuer responses across a customer or customer(s). The system may determine if this payment method has appeared on other accounts. The system may store only critical information related to anomaly.

In some embodiments, the system 100 may further include a simulation environment. This environment may allow testing of new strategies using historical data and assess potential impacts of rule changes on false positive and negative rates. For example, when adding a new rule or determining whether to remove a rule, the system may access the previous ninety-day window and/or determine how many of the transactions or actions would trigger this rule. The system may then break those transactions and/or actions down by, for example, how many were truly anomalous and how many were not. If the ratio of those two things is higher than the specific percent, the system may either add or remove a rule. Some embodiments obtain data (e.g., transactions, returns, changes to the accounts) from a previous time period (e.g., previous 3 months) and simulate the rule being in place at the time the transaction occurred. The system may then measure (i) how many non-anomalous transactions that may incur friction (e.g., ask for additional verification or decline), (ii) how much revenue that may be impacted (e.g., by potentially declining/cancelling an order), (iii) how much actual anomaly that may be captured with that rule, and (iv) how much potential anomalies (e.g., fraud) that may happen if the rule if not implemented. Based on (i) monetary impact to business, (ii) monetary impact to customer, and/or (iii) friction to good customers, the system may implement the rule.

In this way, the system 100 may protect an e-commerce platform throughout a user journey, starting from account creation. The system 100 may integrate at multiple touchpoints, allow for a comprehensive view of user behavior. The system 100 may address the need for less friction for good customers while stopping more anomaly, focus on early detection and prevention, before for example, fraud is committed and personally identifiable information is compromised. The system 100 may include the ability to dynamically add new services at scale. The system 100 may be configured to detect and prevent anomalous activities at the earliest possible stage of the user journey, including account creation. The system 100 may be configured to continuously update risk assessments based on ongoing user interactions; provide reduced friction for legitimate users while maintaining heightened security against potential fraudsters. The system 100 may be configured to dynamically adapt to new services or verticals added to the e-commerce platform.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. An anomaly detection system for protecting an e-commerce platform throughout a user's journey, the system comprising:
a unified application interface configured to:
integrate with a plurality of user touchpoints;
receive attributes associated with each user touchpoint; and
return a decision of block, allow, or challenge for a user action;
a data ingestion pipeline configured to:
capture and process real-time data from each integrated touchpoint; and
at least one of transform or store the processed data in a anomaly data lake;
a graphical database configured to:
link data associated with user interactions, user devices, user accounts, and/or user transactions across the e-commerce platform; and
update the linked data with new data from the data ingestion pipeline;
a neural network associated with the graphical database, configured to:
analyze the linked data to generate predictions of user identities and/or detect patterns indicative of anomalous behavior; and
based on at least one of the predictions or detected patterns, provide real-time risk assessments for each user action;
a plurality of machine learning models configured to:
use data from the anomaly data lake and real-time predictions from the neural network to generate risk scores for the user accounts and/or the user transactions; and
an anomaly orchestration system configured to:
apply a set of dynamic rules to the real-time risk assessments from the neural network and the risk scores from the plurality of machine learning models, to implement a anomaly prevention action including at least one of a blocking action, an allowance, a challenge, for each user action.

2. The anomaly detection system of claim 1, wherein:
the plurality of machine learning models includes an account risk scoring model, a transaction risk scoring model, and a refund risk scoring model, and
the account risk scoring model is configured to:
generate an account risk score for each user account; and
receive and use transaction risk scores and refund risk scores as features in subsequent account risk score calculations;
the transaction risk scoring model is configured to:
receive the account risk score; and
generate a transaction risk score using the account risk score for each transaction; and
the refund risk scoring mode is configured to:
receive the account risk score and the transaction risk score; and
generate a refund risk score for each return request using the account risk score and the transaction risk score.

3. The anomaly detection system of claim 1, wherein the plurality of machine learning models further comprises:
an account creation risk model configured to assess a likelihood of anomalous account creation attempts; and
a behavior anomaly detection model configured to identify deviations from a user's established patterns of activity.

4. The anomaly detection system of claim 1, wherein the graphical database is further configured to:
establish connections between seemingly unrelated accounts based on shared attributes including IP addresses, device fingerprints, or behavioral patterns; and
provide a visual representation of the connections for manual review in complex anomaly cases.

5. The anomaly detection system of claim 1, wherein the system is configured to detect and prevent anomalous activities at the earliest possible stage of the user journey, including account creation, by:
analyzing the attributes received by the unified application interface during account creation, including IP address, Device ID, and user action patterns;
using the neural network to compare the attributes against known anomalous patterns stored in the graphical database;
using the account risk scoring model to generate an initial risk score for the new account; and
triggering the anomaly orchestration system to block or challenge the account creation if the risk score exceeds a predetermined threshold.

6. The anomaly detection system of claim 1, wherein the anomaly orchestration system is further configured to:
dynamically adjust a level of authentication required based on calculated risk scores and specific action being performed; and
implement a gradual step-up in security measures for actions deemed increasingly risky, to balance user experience with anomaly prevention.

7. The anomaly detection system of claim 1, wherein the anomaly orchestration system is further configured to:
route high-risk actions determined based on the risk assessments and the scores to additional verification services when necessary.

8. The anomaly detection system of claim 1, wherein the unified application interface is further configured to:
integrate with additional touchpoints including password reset requests, payment method changes, and shipping address updates; and
assign different risk thresholds for each touchpoint based on a potential impact of anomalous activity at that stage of the user journey.

9. The anomaly detection system of claim 1, wherein the data ingestion pipeline is further configured to:
process and correlate data from multiple touchpoints to create a user behavior profile; and
identify and flag sudden changes in user behavior patterns for immediate risk assessment, based on the user behavior profile.

10. The anomaly detection system of claim 1, wherein the system is further configured to:
generate and maintain a risk profile for each user that evolves throughout their journey on the e-commerce platform; and
use the risk profile to inform decisions at each subsequent touchpoint, providing a seamless and adaptive anomaly prevention experience.

11. The anomaly detection system of claim 1, wherein the system is further configured to:
detect and prevent account takeover attempts by analyzing login patterns, device changes, and account activity; and
implement verification steps for high-risk account changes.

12. The anomaly detection system of claim 1, wherein the neural network is further configured to:
use unsupervised learning techniques to identify new, previously unknown patterns of anomalous behavior; and
adjust anomaly prediction models in real-time based on outcomes of challenged or blocked actions.

13. The anomaly detection system of claim 1, further comprising a rules engine configured to:
allow for creation and modification of anomaly detection rules without requiring system downtime; and
automatically suggest new rules based on patterns identified by the neural network and machine learning models.

14. The anomaly detection system of claim 1, wherein the anomaly orchestration system is further configured to:
dynamically route transactions or actions to different anomaly prevention services based on specific characteristics of the action and current risk assessment; and
aggregate and reconcile decisions from multiple anomaly prevention services when necessary.

15. The anomaly detection system of claim 1, wherein the system continuously updates risk assessments based on ongoing user interactions by:
capturing and processing real-time data from each user interaction through the data ingestion pipeline;
updating the graphical database with new interaction data to refine the user's behavioral profile;
re-analyzing the updated data using the neural network to detect any new patterns indicative of anomalous behavior;
recalculating risk scores using the machine learning models after each significant user action or at regular intervals; and
adjusting the anomaly prevention actions taken by the anomaly orchestration system based on the recalculated risk scores.

16. The anomaly detection system of claim 1, further comprising dynamically adapting to new services or verticals added to the e-commerce platform by:
configuring the unified application interface to automatically integrate with new touchpoints introduced by added services or verticals;
updating the data ingestion pipeline to capture and process data specific to the added services or verticals;
extending schema of the graphical database to accommodate new types of user interactions and relationships relevant to the added services;
retraining the neural network and machine learning models to recognize patterns and assess risks within a context of the new services; and
updating a rule set of the anomaly orchestration system to include anomaly prevention strategies tailored to specific risks associated with the new services or verticals.

17. The anomaly detection system of claim 1, wherein the system provides reduced friction for legitimate users while maintaining heightened security against potential bad actors by:
utilizing the neural network and machine learning models to establish a baseline of normal behavior for each user;
comparing each user action against a personalized baseline to identify deviations;
implementing a tiered authentication system within the anomaly orchestration system, where a level of authentication required is dynamically adjusted based on a current risk assessment;
allowing low-risk actions to proceed with minimal intervention, while applying additional security measures only to high-risk actions; and
continuously refining a risk profile of the user to more accurately distinguish between legitimate and potentially anomalous activities.

18. The anomaly detection system of claim 1, further comprising a feature store configured to:
maintain a repository of pre-computed features derived from historical data across all touchpoints; and
provide the features in real-time to the machine learning models and neural network for faster and more accurate risk assessments.

19. The anomaly detection system of claim 1, further comprising a reporting and analytics module configured to:
provide real-time dashboards showing anomaly prevention performance across all touchpoints; and
generate detailed reports on emerging anomaly patterns and effectiveness of various anomaly prevention measures.

20. The anomaly detection system of claim 1, wherein the system is further configured to:
integrate with third-party data sources to enrich user and transaction data for more accurate risk assessments; and
maintain compliance with data privacy regulations by implementing data minimization and purpose limitation principles.

21. The anomaly detection system of claim 1, further comprising a simulation environment configured to:
allow testing of new anomaly detection strategies using historical data before deployment; and
assess a potential impact of rule changes on false positive and false negative rates.
